(19) United States
(12) Patent Application Publication
(10) Pub. No.: US 2019/0165610 A1
(43) Pub. Date: May 30, 2019

(54) WIRELESS POWER TRANSMITTER AND METHOD FOR CONTROLLING THE SAME

(71) Applicant: Samsung Electro-Mechanics Co., Ltd., Suwon-si (KR)

(72) Inventors: Yun Ki HONG, Suwon-si (KR); Joung Ho SON, Suwon-si (KR); Eun Young SHIN, Suwon-si (KR); Dae Sik KIM, Suwon-si (KR); Hyo Young KIM, Suwon-si (KR); Seung Won PARK, Suwon-si (KR)

(73) Assignee: Samsung Electro-Mechanics Co., Ltd., Suwon-si (KR)

(21) Appl. No.: 16/029,754

(22) Filed: Jul. 9, 2018

(30) Foreign Application Priority Data
Nov. 30, 2017 (KR) 10-2017-0163252

(51) Int. Cl. H02J 50/12; H02J 50/80; H02J 7/02

(52) U.S. Cl. CPC H02J 50/12; H02J 7/025; H02J 50/80

(57) ABSTRACT

A wireless power transmitter includes a first resonance circuit having first resonance characteristics; a second resonance circuit having second resonance characteristics different from the first resonance characteristics; a first inverter configured to provide alternating current (AC) power to the first resonance circuit using an input direct current (DC) power; a second inverter configured to provide the AC power to the second resonance circuit using the input DC power; and a controller configured to control the first inverter and the second inverter to cause the first resonance circuit to wirelessly transmit power, and to cause the second resonance circuit to transmit an external object sensing signal while the first resonance circuit wirelessly transmits power.

### CROSS-REFERENCE TO RELATED APPLICATION(S)

This application claims benefit under 35 U.S.C. § 119(a) of Korean Patent Application No. 10-2017-0163252 filed on Nov. 30, 2017 in the Korean Intellectual Property Office, the entire disclosure of which is incorporated herein by reference for all purposes.

### BACKGROUND

### 1. Field

The following description relates to a wireless power transmitter and a method for controlling the same.

### 2. Description of Related Art

In accordance with the development of wireless technology, wireless functions range from the transmission of data to the transmission of power. In particular, a wireless charging technology capable of charging an electronic device with power, even in a non-contact state, has recently been developed.

For example, the wireless charging technology may be applied to various types of device such as smartphones, wearable watches, and other electronic devices. In addition, as a user may also have various types of devices, it may be desirable to charge different types of devices using a single wireless power transmitter, or to charge a multiple devices using a single wireless power transmitter.

In addition, there are demands for low cost and miniaturization of a wireless power transmitter together with the above-mentioned objectives.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wireless power transmitter includes: a first resonance circuit having first resonance characteristics; a second resonance circuit having second resonance characteristics different from the first resonance characteristics; a first inverter configured to provide alternating current (AC) power to the first resonance circuit using an input direct current (DC) power; a second inverter configured to provide the AC power to the second resonance circuit using the input DC power; and a controller configured to control the first inverter and the second inverter to cause the first resonance circuit to wirelessly transmit power, and to cause the second resonance circuit to transmit an external object sensing signal while the first resonance circuit wirelessly transmits power.

The controller may be further configured to control the first inverter and the second inverter to cause the second resonance circuit transmit a reception confirmation signal, in response to it being determined, using the second resonance circuit, that an external object is located adjacent to the wireless power transmitter while the first resonance circuit wirelessly transmits the power.

The controller may be further configured to control the first inverter and the second inverter to operate in a standby mode in which each of the first resonance circuit and the second resonance circuit transmits a ping signal, a single charge mode in which the power is provided to a first wireless power receiver using the first resonance circuit, based on a response signal received from the first wireless power receiver, and a multi-charge mode in which the power is provided to a second wireless power receiver using the second resonance circuit, based on a response signal received from the second wireless power receiver during the single charge mode.

The controller may be further configured to control the first resonance circuit and the second resonance circuit to continuously transmit the ping signal once per predetermined period in the standby mode.

The may be further configured to control the second resonance circuit to transmit the ping signal in the single charge mode.

The controller may include a first control signal generator configured to generate a first control signal provided to the first inverter, a second control signal generator configured to generate a second control signal provided to the second inverter, and a phase controller configured to change operation phases of the first control signal generator and the second control signal generator according to operating modes including a standby mode, a single charge mode, and a multi-charge mode.

The wireless power transmitter may further include a demodulator connected to either one of the first resonance circuit and the second resonance circuit, and configured to demodulate a communications signal received through either one of the first resonance circuit and the second resonance circuit.

The controller may be configured to perform controlling to connect the demodulator to either one of the first resonance circuit and the second resonance circuit according to operating modes.

The operating modes may include any one or any combination of any two or more of a standby mode in which each of the first resonance circuit and the second resonance circuit transmits a ping signal, a single charge mode in which the power is provided to a first wireless power receiver using the first resonance circuit, based on a response signal received from the first wireless power receiver, and a multi-charge mode in which the power is provided to a second wireless power receiver using the second resonance circuit, based on a response signal received from the second wireless power receiver during the single charge mode.

In the standby mode, the demodulator may be connected to the second resonance circuit while the second resonance circuit transmits the ping signal, and the demodulator may be connected to the first resonance circuit at other times.

In the single charge mode, the demodulator may be connected to the second resonance circuit while the second resonance circuit transmits the ping signal, and the demodulator may be connected to the first resonance circuit at other times.

In the multi-charge mode, the demodulator may be alternately connected to the first resonance circuit and the second resonance circuit in a time-division manner.

In another general aspect, a method to operate a wireless power transmitter includes: controlling each of a first resonance circuit of the wireless power transmitter and a second resonance circuit of the wireless power transmitter to transmit a ping signal; controlling the first resonance circuit to provide power to a first wireless power receiver, in response to a response signal being received from the first wireless power receiver through the first resonance circuit; and controlling the second resonance circuit to transmit the ping signal while the first resonance circuit provides the power, wherein resonance characteristics of the second resonance circuit are different from resonance characteristics of the first resonance circuit.

The method may further include controlling the second resonance circuit to provide the power to a second wireless power receiver, in response to another response signal being received from the second wireless power receiver through the second resonance circuit.

The wireless power transmitter may include a demodulator connected to either one of the first resonance circuit and the second resonance circuit, and the controlling of the second resonance circuit to transmit the ping signal may include connecting the demodulator to the second resonance circuit while the second resonance circuit transmits the ping signal and connecting the demodulator to the first resonance circuit at other times.

The wireless power transmitter may include a demodulator connected to either one of the first resonance circuit and the second resonance circuit, and the controlling of the second resonance circuit to provide the power to the second wireless power receiver may include alternately connecting the demodulator to the first resonance circuit and the second resonance circuit in a time-division manner.

In another general aspect, a non-transitory, computer-readable storage medium stores instructions that, when executed by a processor, cause the processor to perform the method to operate the wireless power transmitter.

Other features and aspects will be apparent from the following detailed description, the drawings, and the claims.

### BRIEF DESCRIPTION OF DRAWINGS

FIG. 1 is a diagram illustrating an example application of a wireless power transmitter, according to an embodiment.

FIG. 2 is a block diagram illustrating the wireless power transmitter of FIG. 1, according to an embodiment.

FIG. 3 is a diagram providing a description of each of phases of wireless power transmission performed by a controller illustrated in FIG. 2, according to an embodiment.

FIG. 4 is a block diagram illustrating the controller illustrated in FIG. 2, according to an embodiment.

FIG. 5 is a block diagram illustrating a wireless power transmitter, according to another embodiment.

FIG. 6 is a flowchart illustrating a method for controlling a wireless power transmitter, according to an embodiment.

FIG. 7 is a flowchart illustrating a method for controlling a wireless power transmitter, according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

The features of the examples described herein may be combined in various ways as will be apparent after an understanding of the disclosure of this application. Further, although the examples described herein have a variety of configurations, other configurations are possible as will be apparent after an understanding of the disclosure of this application.

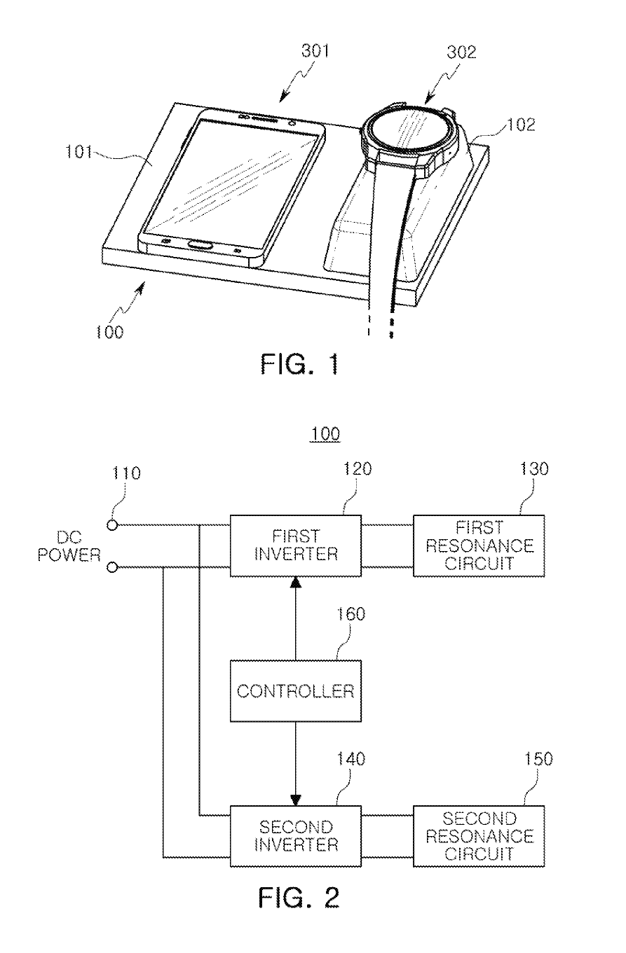

FIG. 1 is a diagram illustrating an example application of a wireless power transmitter 100, according to an embodiment.

Referring to FIG. 1, the wireless power transmitter 100 may charge different devices 300 and 301 of different types. For example, the device 300 is a smartphone, and the device 301 is a wearable device, such as a smartwatch.

The smartphone 300 and the wearable device 301 may each include a wireless power receiver, and the wireless power transmitter 100 may wirelessly supply power to the wireless power receiver. However, since FIG. 1 does not explicitly illustrate the wireless power receivers, the target of wireless charging will be collectively referred to as the smartphone 300 and the wearable device 301.

Although FIG. 1 illustrates an example in which the wireless power transmitter 100 simultaneously charges the smartphone 300 and the wearable device 301, the wireless power transmitter 100 may also charge only the smartphone 300 or the wearable device 301 in some cases.

The wireless power transmitter 100 may supply power separately to the smartphone 300 and the wearable device 301 using different resonance circuits 101 and 102 based on one input power.

Since resonance characteristics for the smartphone 300 and resonance characteristics for the wearable device 301 are different from each other, the wireless power transmitter 100 may include resonance circuits 101 and 102 having different resonance characteristics, and may separately control the resonance circuits.

FIG. 2 is a block diagram illustrating the wireless power transmitter 100, according to an embodiment.

Referring to FIG. 2, the wireless power transmitter 100 includes an input terminal 110 receiving a direct current (DC) power, a first inverter 120, a first resonance circuit 130, a second inverter 140, a second resonance circuit 150, and a controller 160.

Input power may be supplied through the input terminal 110. The input power may be DC power. Therefore, the input DC power may be formed across the input terminal 110.

The input DC power may be provided by a power adapter (not shown) providing the DC power to the wireless power transmitter 100. Alternatively, according to an embodiment, the wireless power transmitter 100 may further include a power supplying unit, or power supply, (not shown) receiving alternating current (AC) power and supplying the input power, and the input DC power may be provided by such a power supplying unit.

The first resonance circuit 130 and the second resonance circuit 150 may have different resonance characteristics. That is, the first resonance circuit 130 may be set to have first resonance characteristics, and the second resonance circuit 150 may be set to have second resonance characteristics that are different from the first resonance characteristics. For example, the first resonance characteristics may be suitable for wireless charging of a portable device such as a smartphone, and the second resonance characteristics may be suitable for wireless charging of a wearable device such as a smartwatch.

In addition, the first resonance circuit 130 and the second resonance circuit 150 may be supplied an alternating current (AC) power from different inverters. For example, the first inverter 120 may provide an alternating current to the first resonance circuit 130 by using the input DC power, and the second inverter 140 may provide the alternating current to the second resonance circuit 150 by using the input DC power.

According to an exemplary embodiment, the first inverter 120 or the second inverter 140 may be a step-up inverters that simultaneously perform a step-up and a conversion into AC by using one switch circuit configuration, for example, a bridge circuit structure.

The controller 160 may control the first inverter 120 and the second inverter 140. The controller 160 may provide a first control signal to the first inverter 120 to control an operation of the first inverter 120, and may provide a second control signal to the second inverter 140 to control an operation of the second inverter 140. Thus, the controller 160 may independently control the first inverter 120 and the second inverter 140 so that the first resonance circuit 130 and the second resonance circuit 150 operate independently from each other.

As an example, the controller 160 may operate according to a standby mode in which controlling is performed so that each of the first resonance circuit 130 and the second resonance circuit 150 transmits a ping signal, a single charge mode in which power is provided to a first wireless power receiver using either one of the first resonance circuit 130 and the second resonance circuit 150 based on a response signal received from the first wireless power receiver, and a multi-charge mode in which the power is provided to a second wireless power receiver using the other one of the first resonance circuit 130 and the second resonance circuit 150 based on a response signal received from the second wireless power receiver during the single charge mode.

The controller 160 may perform a control so that the first resonance circuit 130 and the second resonance circuit 150 continuously transmit an analog ping signal once per predetermined period in the standby mode.

The controller 160 may perform a control so that the other one of the first resonance circuit 130 and the second resonance circuit 150 (e.g., the one of the first resonance circuit 130 and the second resonance circuit 150 that is not providing the power) transmits the ping signal in the single charge mode.

Alternatively, the controller 160 may separately control the first inverter 120 and the second inverter 140 so that the second resonance circuit 150 transmits the ping signal while the first resonance circuit 130 wirelessly transmits the power.

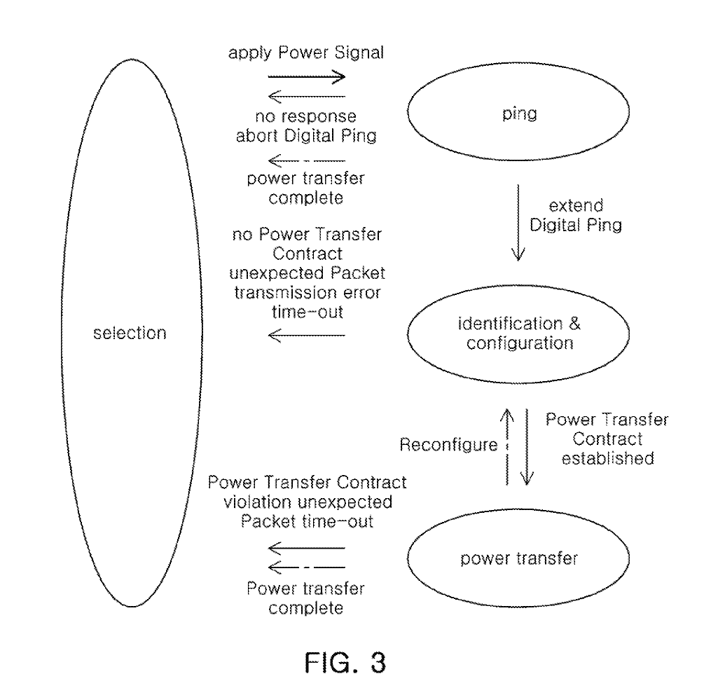

Hereinafter, the respective phases of wireless power transmission illustrated in FIG. 3 will be described, and the above-mentioned modes will be described based on the phases.

FIG. 3 is a diagram illustrating a description of each of phases of wireless power transmission performed by a controller 160 illustrated in FIG. 2.

Referring to FIG. 3, in order to wirelessly transmit power, a selection phase may be initially performed.

In the selection phase, the wireless power transmitter 100 may transmit an external object sensing signal, and determine whether or not an external object is positioned around the wireless power transmitter 100 based on whether a change in the external object sensing signal, for example, a change in impedance, occurs.

The terms “external object sensing signal” collectively refer to a signal for detecting an external object. Therefore, the external object sensing signal may a signal according to various standards or embodiments, such as an analog ping signal, a short beacon signal, or another type of signal.

In the selection phase, if it is determined that the external object exists adjacent to the wireless power transmitter by using the external object sensing signal, the wireless power transmitter 100 may perform a ping phase to confirm whether the external object is the wireless power receiver. That is, the wireless power transmitter 100 may transmit a receiver confirmation signal, and may confirm whether the external object is the wireless power receiver based on a response signal for the receiver confirmation signal provided from the wireless power receiver.

The terms “receiver confirmation signal” collectively refer to a signal for wireless communications with the wireless power receiver, and may be, for example, a digital ping signal, a long beacon signal, or another type of signal performing wireless communications.

In addition, such a receiver confirmation signal may be transmitted in various communications methods. As an example, the receiver confirmation signal and a response signal thereof may be transmitted or received by local area communications such as Bluetooth. As another example, the receiver confirmation signal and a response signal thereof may be transmitted or received by an in-band communications method that modulate a constant signal pattern to a magnetic field formed between the wireless power transmitter 100 and the wireless power receiver.

However, in the above-mentioned description, the external object sensing signal, for example, the analog ping signal or the short beacon signal, and the receiver confirmation signal, for example, the digital ping signal or the long beacon signal are described to be classified, but they are hereinafter collectively referred to as a ping signal.

That is, the selection phase and the ping phase may be executed to be periodically repeated. In addition, the external object sensing signal or the receiver confirmation signal transmitted in the selection phase and the ping phase which are executed to be repeated is collectively referred to as a ‘ping signal’.

If the response signal for the receiver confirmation signal is received, the wireless power transmitter 100 may confirm requirement information for wireless charging, such as a target or a power requirement of wireless charging, from the response signal received from the wireless power receiver. Receipt of the response signal for the receiver confirmation signal, and confirmation of the requirement information for wireless charging are collectively referred to as an identification & configuration phase.

Thereafter, the wireless power transmitter 100 may wirelessly transfer power to the wireless power receiver according to the confirmed requirement information. The transferring of power to the wireless power receiver is referred to a power transfer phase.

The selection phase, the ping phase, the identification & configuration phase, and the power transfer phase described above may be differently executed for each of the first and second resonance circuits 130 and 150. Therefore, a case in which the first resonance circuit 130 and the second resonance circuit 150 are in the selection phase or the ping phase may correspond to the standby mode. A case in which either one of the first resonance circuit 130 and the second resonance circuit 150 operates in the power transfer phase may correspond to the single charge mode. A case in which the first resonance circuit and the second resonance circuit separately operate in the power transfer phase may correspond to the multi-charge mode.

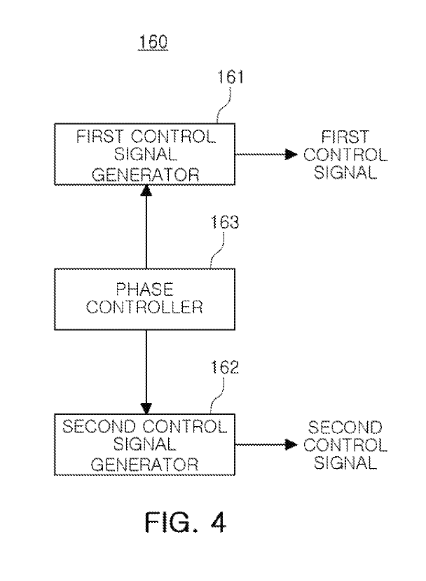

FIG. 4 is a block diagram illustrating an example of a controller illustrated in FIG. 2.

Referring to FIG. 4, the controller 160 includes a first control signal generator 161, a second control signal generator 162, and a phase controller 163.

The first control signal generator 161 may generate a first control signal provided to the first inverter 120. The second control signal generator 162 may generate a second control signal provided to the second inverter 140.

The phase controller 163 may specify operation phases of the first control signal generator 161 and the second control signal generator 162. That is, the phase controller 163 may change the operation phases of the first control signal generator 161 and the second control signal generator 162 according to operating modes including the standby mode, the single charge mode, and the multi-charge mode.

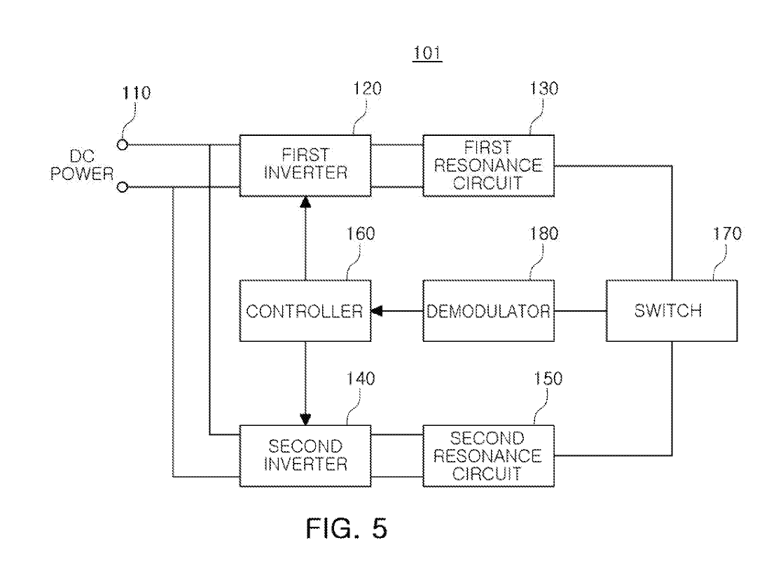

FIG. 5 is a block diagram illustrating a wireless power transmitter 101, according to another embodiment. The embodiment illustrated in FIG. 5 is an embodiment in which connections between a demodulator 180 and the first and second resonance circuits 130 and 150 are varied according to the operating modes.

Referring to FIG. 5, the wireless power transmitter 101 includes the input terminal 110 receiving a direct current (DC) voltage, the first inverter 120, the first resonance circuit 130, the second inverter 140, the second resonance circuit 150, the controller 160, a switch 170, and the demodulator 180.

The input terminal 110, the first inverter 120, the first resonance circuit 130, the second inverter 140, the second resonance circuit 150, and the controller 160 may be understood from the above description of FIGS. 2 through 4. Therefore, the input terminal 110, the first inverter 120, the first resonance circuit 130, the second inverter 140, the second resonance circuit 150, and the controller 160 will not be repeatedly described.

The demodulator 180 may be connected to either one of the first resonance circuit 130 and the second resonance circuit 150 through the switch 170. That is, the demodulator 180 may be connected to the first resonance circuit 130 or the second resonance circuit 150, and may demodulate a communications signal received through the first resonance circuit 130 or the second resonance circuit 150.

The demodulator 180 may demodulate a signal modulated in an in-band method, that is, a signal modulated based on a magnetic field formed between the wireless power transmitter 101 and the wireless power receiver.

The switch 170 may connect the demodulator 180 to either one of the first resonance circuit 130 and the second resonance circuit 150 according to a control of the controller 160. The controller 160 may control an operation of the switch 170 according to the operating modes.

For example, as described above, the operating modes may include a standby mode in which each of the first resonance circuit 130 and the second resonance circuit 150 is controlled to transmit a ping signal, a single charge mode in which power is provided to a first wireless power receiver using either one of the first resonance circuit 130 and the second resonance circuit 150 based on a response signal received from the first wireless power receiver, and a multi-charge mode in which the power is provided to a second wireless power receiver using the other one of the first resonance circuit 130 and the second resonance circuit 150 based on a response signal received from the second wireless power receiver during the single charge mode.

As an example, in the standby mode, the demodulator 180 may be connected to the first resonance circuit 130 as a basic or default setting. In this state, the response signal transmitted from the wireless power receiver may be input to the demodulator 180 through the first resonance circuit 130 and the demodulator 180 may demodulate the input response signal.

While the second resonance circuit 150 transmits the ping signal in the standby mode, the demodulator 180 may be connected to the second resonance circuit 150. In more detail, during a predetermined time after the second resonance circuit 150 transmits the receiver confirmation signal, the demodulator 180 may be connected to the second resonance circuit 150. If the demodulator 180 is connected to the second resonance circuit 150, the response signal transmitted from the wireless power receiver may be input to the demodulator 180 through the second resonance circuit 150 and the demodulator 180 may demodulate the input response signal.

As an example, in the single charge mode, the demodulator 180 may be connected to a resonance circuit that provides the power to the first wireless power receiver, that is, the one of the first resonance circuit 130 and the second resonance circuit 150 that transmits the power, as a basic or default setting. While the wireless power receiver receives the power, the wireless power receiver may transmit a signal including information on necessary (e.g., required) power. The information may include any one or any combination of any two or more of a magnitude of the necessary power, a difference between the necessary power and received power, and a charged state of a battery. If the power is being transferred through the first resonance circuit 130, the signal transmitted from the wireless power receiver may be transferred to the demodulator 180 through the first resonance circuit 130 and the demodulator 180 may demodulate the signal to extract the information.

In the single charge mode, while either one of the first resonance circuit 130 and the second resonance circuit 150 transmits the ping signal, the demodulator 180 may be connected the other one of the first resonance circuit 130 and the second resonance circuit 150. For example, while the power is being transferred through the first resonance circuit 130 in the single charge mode, the demodulator 180 may be connected to the first resonance circuit 130 in a base or default connection configuration, and the demodulator 180 and the second resonance circuit 150 may be connected to each other while transmitting the ping signal through the second resonance circuit 150 (e.g., during a predetermined time after transmitting the receiver confirmation signal through the second resonance circuit 150). If the demodulator 180 is connected to the second resonance circuit 150, the response signal transmitted from the wireless power receiver may be input to the demodulator 180 through the second resonance circuit 150 and the demodulator 180 may demodulate the input response signal.

As an example, in the multi-charge mode, the demodulator 180 may be alternately connected to the first resonance circuit 130 and the second resonance circuit 150 in a time-divisional manner. That is, in the multi-charge mode, the wireless power transmitter 101 may transmit the power to a plurality of wireless power receivers, and may thus receive the signal including the information on the necessary power from each wireless receiver among the plurality of wireless power receivers. In other words, in the multi-charge mode, the wireless power transmitter 101 may receive a plurality of signals. In the multi-charge mode, the demodulator 180 may alternatively receive and demodulate the plurality of signals.

A connection configuration of the demodulator 180 may be changed by changing a connection target of the switch 170 according to a control of the controller 160.

Although the embodiment of FIG. 5 describes a case in which the wireless power transmitter 101 receives the signal transmitted by the wireless power receiver using the one of the first resonance circuit 130 and the second resonance circuit 150 that is transmitting the power, the wireless power transmitter may further include a separate antenna, coil, or the like for receiving the signal transmitted by the wireless power receiver.

Hereinafter, a method for controlling a wireless power transmitter according to an embodiment in will be described. However, since the method for controlling a wireless power transmitter to be described below is based on the wireless power transmitter 100/101 described above with reference to FIGS. 1 through 5, the method may be easily understood from the description above with reference to FIGS. 1 through 5, and descriptions of overlapping contents will therefore be omitted.

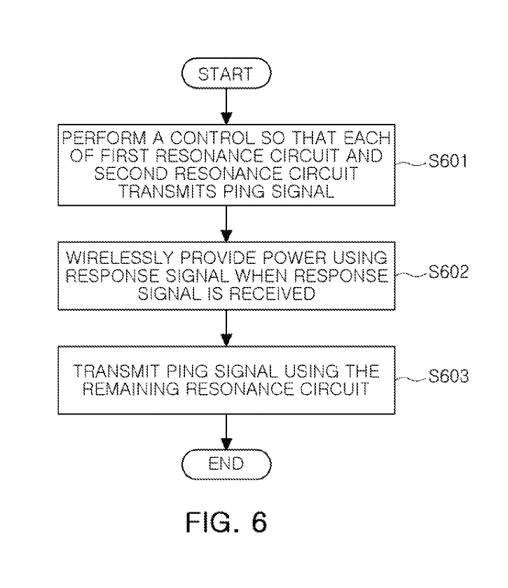

FIG. 6 is a flowchart illustrating a method for controlling a wireless power transmitter, according to an embodiment.

Referring to FIG. 6, in operation S601, the wireless power transmitter may control the first resonance circuit and the second resonance circuit, which have different resonance characteristics, so as to transmit a ping signal using one controller.

If a response signal is received from a first wireless power receiver, in operation S602, the wireless power transmitter may perform a control to provide power to the first wireless power receiver using the one of the first resonance circuit 130 and the second resonance circuit that receives the response signal.

In operation 603, the wireless power transmitter may perform a control so that the other one of the first resonance circuit and the second resonance circuit transmits a ping signal.

According to an embodiment, if the other one of the first resonance circuit and the second resonance circuit receives a response signal from a second wireless power receiver, the wireless power transmitter may perform a control so that the power is provided to the second wireless power receiver using the other one of the first resonance circuit and the second resonance circuit.

The wireless power transmitter may include a demodulator connected to either one of the first resonance circuit and the second resonance circuit. The wireless power transmitter may perform a control so that the demodulator is alternately connected to the first resonance circuit and the second resonance circuit in a time-divisional manner.

According to an embodiment, the wireless power transmitter may include a demodulator connected to either one of the first resonance circuit and the second resonance circuit. The operation S603 of performing the control so that the other one of the first resonance circuit and the second resonance circuit transmitting the ping signal may include performing controlling so that the demodulator is connected to the one of the first resonance circuit and the second resonance circuit providing the power to the first wireless power receiver as the basic or default setting, and performing controlling so that the demodulator is connected to the other one of the first resonance circuit and the second resonance circuit while the other one of the first resonance circuit and the second resonance circuit transmits the ping signal.

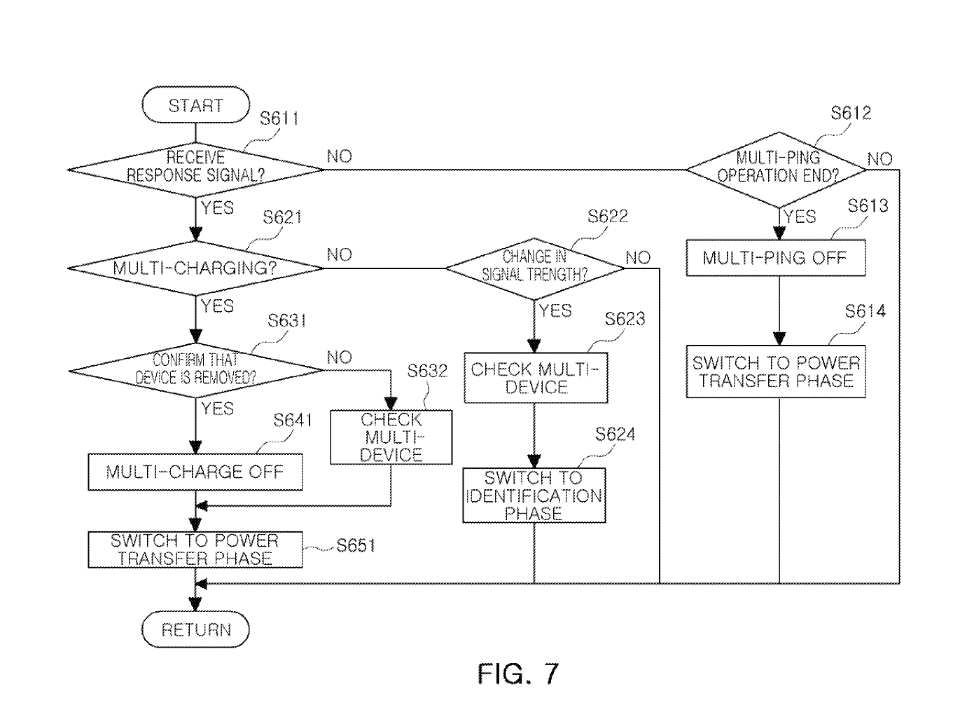

FIG. 7 is a flowchart illustrating a method for controlling a wireless power transmitter, according to another embodiment.

The embodiment illustrated in FIG. 7 is an embodiment in which it is determined whether a multi-charging (charging of multiple devices) is performed or a multi-charging is stopped when a predetermined time has elapsed after the power transmission is performed.

Referring to FIG. 7, in operation 611, the wireless power transmitter may determine whether it receives a response signal. The response signal is provided from the wireless power receiver.

If it is determined in operation S611 that the wireless power transmitter does not receive the response signal (No in operation S611), the wireless power transmitter may determine, in operation S612, whether a multi-ping operation (or a predetermined time transmitting a multi-ping) has elapsed.

If the multi-ping operation ends (Yes in S612), the wireless power transmitter may end the multi-ping phase in operation S613 and switch to a power transfer phase in operation S614.

If the wireless power transmitter determines that it receives the response signal (Yes in S611), the wireless power transmitter may determine, in operation S621, whether a current state is a multi-charging state.

If it is determined in operation S621 that the current state is not the multi-charging state and it is determined in operation S622 that a signal strength is changed (Yes in operation S622), the wireless power transmitter may check for an existence of a multi-device condition (e.g., multiple devices present within a vicinity or a charging range of the wireless power transmitter) in operation S623 because the changed signal strength indicates that there is a new device present. Accordingly, in operation S624, the wireless power transmitter may switch to an identification phase for checking the existence of the multi-device condition and performing communications.

If it is determined in operation S611 that the wireless power transmitter receives the response signal, and it is determined in operation S621 that the current state is the multi-charging state (Yes in S621), this may correspond to a case in which multi-charging is being performed in error. Therefore, the wireless power transmitter may determine whether a device is removed in operation S631, and may end the multi-charging in operation S641 if it is determined that the device is removed.

If it is determined in operation S631 that no devices are removed, the wireless power transmitter may re-confirm whether a multi-device condition is correct in operation S632.

Thereafter, the wireless power transmitter may perform a switching so that the power transfer phase is executed on the remaining devices in operation S651.

As set forth above, according to the embodiments disclosed herein, a wireless power transmitter may satisfy the requirements of low cost and miniaturization while charging multiple devices. Furthermore, a wireless power transmitter according to a disclosed embodiment may satisfy the requirements of low cost and miniaturization while supporting various charging standards.

The first inverter 120 and the second inverter 140 of FIGS. 2 and 5, the controller 160 of FIGS. 2, 4, and 5, the first control signal generator 161, the second control signal generator 162, and the phase controller 163 of FIG. 4, and the demodulator 180 of FIG. 5 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 3, 6, and 7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmitter, comprising:
a first resonance circuit having first resonance characteristics;
a second resonance circuit having second resonance characteristics different from the first resonance characteristics;
a first inverter configured to provide alternating current (AC) power to the first resonance circuit using an input direct current (DC) power;
a second inverter configured to provide the AC power to the second resonance circuit using the input DC power; and
a controller configured to control the first inverter and the second inverter to cause the first resonance circuit to wirelessly transmit power, and to cause the second resonance circuit to transmit an external object sensing signal while the first resonance circuit wirelessly transmits power.

2. The wireless power transmitter of claim 1, wherein the controller is further configured to control the first inverter and the second inverter to cause the second resonance circuit transmit a reception confirmation signal, in response to it being determined, using the second resonance circuit, that an external object is located adjacent to the wireless power transmitter while the first resonance circuit wirelessly transmits the power.

3. The wireless power transmitter of claim 1, wherein the controller is further configured to control the first inverter and the second inverter to operate in
a standby mode in which each of the first resonance circuit and the second resonance circuit transmits a ping signal,
a single charge mode in which the power is provided to a first wireless power receiver using the first resonance circuit, based on a response signal received from the first wireless power receiver, and
a multi-charge mode in which the power is provided to a second wireless power receiver using the second resonance circuit, based on a response signal received from the second wireless power receiver during the single charge mode.

4. The wireless power transmitter of claim 3, wherein the controller is further configured to control the first resonance circuit and the second resonance circuit to continuously transmit the ping signal once per predetermined period in the standby mode.

5. The wireless power transmitter of claim 3, wherein the controller is further configured to control the second resonance circuit to transmit the ping signal in the single charge mode.

6. The wireless power transmitter of claim 1, wherein the controller comprises
a first control signal generator configured to generate a first control signal provided to the first inverter,
a second control signal generator configured to generate a second control signal provided to the second inverter, and
a phase controller configured to change operation phases of the first control signal generator and the second control signal generator according to operating modes including a standby mode, a single charge mode, and a multi-charge mode.

7. The wireless power transmitter of claim 1, further comprising a demodulator connected to either one of the first resonance circuit and the second resonance circuit, and configured to demodulate a communications signal received through either one of the first resonance circuit and the second resonance circuit.

8. The wireless power transmitter of claim 7, wherein the controller is configured to perform controlling to connect the demodulator to either one of the first resonance circuit and the second resonance circuit according to operating modes.

9. The wireless power transmitter of claim 8, wherein the operating modes include any one or any combination of any two or more of
a standby mode in which each of the first resonance circuit and the second resonance circuit transmits a ping signal,
a single charge mode in which the power is provided to a first wireless power receiver using the first resonance circuit, based on a response signal received from the first wireless power receiver, and
a multi-charge mode in which the power is provided to a second wireless power receiver using the second resonance circuit, based on a response signal received from the second wireless power receiver during the single charge mode.

10. The wireless power transmitter of claim 9, wherein in the standby mode, the demodulator is connected to the second resonance circuit while the second resonance circuit transmits the ping signal, and the demodulator is connected to the first resonance circuit at other times.

11. The wireless power transmitter of claim 9, wherein, in the single charge mode, the demodulator is connected to the second resonance circuit while the second resonance circuit transmits the ping signal, and the demodulator is connected to the first resonance circuit at other times.

12. The wireless power transmitter of claim 9, wherein in the multi-charge mode, the demodulator is alternately connected to the first resonance circuit and the second resonance circuit in a time-division manner.

13. A method to operate a wireless power transmitter, the method comprising:
controlling each of a first resonance circuit of the wireless power transmitter and a second resonance circuit of the wireless power transmitter to transmit a ping signal;
controlling the first resonance circuit to provide power to a first wireless power receiver, in response to a response signal being received from the first wireless power receiver through the first resonance circuit; and
controlling the second resonance circuit to transmit the ping signal while the first resonance circuit provides the power to the first wireless receiver,
wherein resonance characteristics of the second resonance circuit are different from resonance characteristics of the first resonance circuit.

14. The method of claim 13, further comprising controlling the second resonance circuit to provide the power to a second wireless power receiver, in response to another response signal being received from the second wireless power receiver through the second resonance circuit.

15. The method of claim 13, wherein the wireless power transmitter comprises a demodulator connected to either one of the first resonance circuit and the second resonance circuit, and
the controlling of the second resonance circuit to transmit the ping signal comprises connecting the demodulator to the second resonance circuit while the second resonance circuit transmits the ping signal and connecting the demodulator to the first resonance circuit at other times.

16. The method of claim 14, wherein the wireless power transmitter comprises a demodulator connected to either one of the first resonance circuit and the second resonance circuit, and
the controlling of the second resonance circuit to provide the power to the second wireless power receiver comprises alternately connecting the demodulator to the first resonance circuit and the second resonance circuit in a time-division manner.

17. A non-transitory, computer-readable storage medium storing instructions that, when executed by a processor, cause the processor to perform the method of claim 13.
